(19) United States
(12) Patent Application Publication
(10) Pub. No.: US 2021/0209424 A1
(43) Pub. Date: Jul. 8, 2021

(54) COMPUTER-BASED METHOD AND SYSTEM FOR PREDICTING AND GENERATING LAND USE LAND COVER (LULC) CLASSIFICATION

(71) Applicant: QUANTELA INC, Milpitas, CA (US)

(72) Inventors: Sanjiv Kumar Jha, Bangalore (IN); Vikash Shivhare, Madhya Pradesh (IN); Sumedh Ghatage, Kolhapur (IN); Shubham Agarwal, Uttar Pradesh (IN)

(21) Appl. No.: 16/735,442

(22) Filed: Jan. 6, 2020

(51) Int. Cl. G06K 9/62; G06K 9/00; G06N 3/08; G06N 20/00

(52) U.S. Cl. CPC G06K 9/6268; G06K 9/628; G06N 20/00; G06K 9/0063; G06N 3/084; G06K 9/6228

(57) ABSTRACT

Computer-based method and system for predicting Land Use Land Cover (LULC) classification of a geographic area using trained deep learning model are described herein. The method and system facilitate a user, without any hard knowledge of geographic information system (GIS) to get LULC classification of a geographic area with a fully automated, single step, and single input process.

### FIELD OF THE INVENTION

Embodiments described herein in general, concern computer-based method and system for predicting and generating land use land cover (LULC) classification. More particularly, the embodiments concern to a fully automated geospatial artificial intelligence (Geo-AI) based method and system for predicting land use land cover (LULC) classification of a geographic area using a trained deep learning model.

### CROSS-REFERENCES

Various methods, systems, apparatus, and technical details relating to the present invention are disclosed in the following co-pending applications filed by the applicant or assignee of the present invention. The disclosures of all of these co-pending/granted applications are incorporated herein by cross-reference.

Co-pending application titled “COMPUTER-BASED METHOD AND SYSTEM FOR GEO-SPATIAL ANALYSIS.”
Co-pending application titled “COMPUTER-BASED METHOD AND SYSTEM FOR URBAN PLANNING.”
Co-pending application titled “COMPUTER-BASED METHOD AND SYSTEM FOR DETERMINING GROUNDWATER POTENTIAL ZONES.”

### BACKGROUND OF THE INVENTION

Unless otherwise indicated herein, the approaches described in this section are not prior art to the claims in this application and are not admitted to be prior art by inclusion in this section.

Land management and land planning requires information about the present scenario of the landscape as changes in land use land cover (LULC) are rapid in nature and can affect the societal surroundings in adverse manner Remotely sensed images processed with classification methods provide a mean to analyse land resource information. Landsat data is one of the most significant resources in medium resolution remote sensing image classification. Many classification methods have gradually emerged in remote sensing image classification, and mainly include machine learning algorithms such as Multilayer Perceptron (MLP), Support Vector Machine (SVM) classification, and fuzzy number (Fuzzy Theory) classification etc. These algorithms do not perform well on large scale Landsat image classification. The conventional classification methods are not fully automated, training samples required to train the deep learning models are inputted/selected by the user. Therefore, the user must have a good knowledge of geographic information system (GIS) for selecting the training samples.

Hence, it is apparent that a need exists for a Geo-spatial artificial intelligence (Geo-AI) based fully automated computer-based method and system for predicting land use land cover (LULC) classification of a geographic area using a trained deep learning model.

### SUMMARY OF THE INVENTION

According to an embodiment, a computer-implemented method for generating land use land cover (LULC) classification of a geographic area is described. The computer-implemented method comprises receiving a first input defining a geographic area and a first time frame. The computer-implemented method further comprises automatically retrieving a first set of satellite images corresponding to the geographic area and the first time frame. The computer-implemented method further comprises automatically classifying the first set of satellite images into a plurality of land use land cover (LULC) classes using a trained deep learning model, and automatically presenting a visualization depicting the LULC classification of the geographic area.

According to an example, the plurality of land use land cover (LULC) classes may include at least one of vegetation cover, surface water cover, built-up area, barren/open land, and cropland.

According to an example, the computer-implemented method may further comprise creating a training set including a plurality of satellite images, and automatically training a deep learning model using the training set and a neural network to develop the trained deep learning model.

According to an example, creating a training set may further comprise automatically retrieving a plurality of satellite images corresponding to a plurality of geographic areas, automatically fetching a plurality of spectral bands corresponding to the plurality of satellite images, automatically processing the plurality of spectral bands to convert digital number of each pixel of the plurality of spectral bands into reflectance or radiance values, and creating the training set in the form of creating pixel-wise shapefiles corresponding to each of the plurality of LULC classes.

According to an example, automatically retrieving a plurality of satellite images may include automatically selecting and retrieving satellite images with at most 5 percent cloud coverage from one or more servers.

According to an example, automatically training a deep learning model may further comprise automatically training the deep learning model using the pixel reflectance or radiance values of the plurality of spectral bands, and the training set as inputs to the neural network.

According to an example, the neural network may include a convolution layer, activation function, pooling layer, and fully-connected layer.

According to an example, automatically training the deep learning model may further comprise automatically calculating a loss value based on differences among the input pixel values and ground truth values, automatically performing back propagation, and automatically updating weights corresponding to each layer of the neural network.

According to an example, the computer-implemented method may further comprise automatically calculating a quantitative value of an area covered by pixels of each LULC class.

According to an example, automatically presenting a visualization depicting the LULC classification of the geographic area may include automatically presenting the area covered by the pixels of each LULC class on an image of the geographic area.

According to an example, the computer-implemented method may further comprise receiving a second input defining a second time frame, automatically retrieving a second set of satellite images corresponding to the geographic area and the second time frame, automatically classifying the second set of satellite images into a plurality of land use land cover (LULC) classes using a trained deep learning model, and automatically presenting a visualization depicting a comparison of the land use land cover (LULC) classes of the first and the second set of satellite images, the comparison illustrating a quantitative relative change in the land use land cover (LULC) classes of the geographic area over a time duration from the first time frame to the second time frame.

According to another exemplary embodiment, a system for generating land use land cover (LULC) classification of a geographic area is described. The system comprises at least one processor and at least one computer readable memory coupled to the at least one processor, and the processor is configured to perform all or some steps of the method described above.

According to another exemplary embodiment, a non-transitory computer readable medium is described. The non-transitory computer readable medium comprises a computer-readable code comprising instructions, which when executed by a processor, causes the processor to perform all or some steps of the method described above.

It is an object of the invention to provide a Geo-spatial artificial intelligence (Geo-AI) based fully automated computer-based method and system for predicting land use land cover (LULC) classification of a geographic area using a trained deep learning model where user does not require any hard knowledge of the geographic information system (GIS) for operating the computer-based system.

It is an object of the invention to automatically create training samples for training the deep learning model for predicting LULC classification of a geographic area, where user does not need to input the training samples.

It is an object of the invention to provide an ingeniously created architecture for training the deep learning model for predicting LULC classification.

It is an object of the invention to provide a Geo-spatial artificial intelligence (Geo-AI) based fully automated computer-based method and system with automatic data acquisition and processing where a user does not require any hard knowledge of the geographic information system (GIS). The object is to provide a fully automated computer based method and a system therefore to enable a user to get LULC classification of a geographic area with minimum input (for example, only the ones related to geographic area, and time frame for which analysis is to be performed) and arriving directly at the quantitative assessments of the LULC classes within the geographic area, and that too without the need for the user to have any hard knowledge of the GIS.

It is an object of the invention to link data science with geo-spatial domain knowledge to enable a user with no hard knowledge of GIS to perform the analysis with a single step process.

It is an object of the invention to provide a fully automated computer-based method and system with customization availability for any user.

It is an object of the invention to provide a single input/step process to run the computer-based system or method to arrive at the quantitative analysis of the LULC classification.

It is an object of the invention to automatically provide quantitative statistical measurements of the LULC classification with better visualization within seconds and with a single click. The visualizations facilitate easily interpretable outcomes with granularity.

It is an object of the invention to provide time efficiency, in that, to provide readable outputs of the LULC classification in most time and energy efficient manner.

It is an object of the invention to provide reduced memory consumption. The satellite images and other data-set pre-processing is performed on the one or more servers. The images do not need to be saved for analytical assessments. The process incurred in the analytics is on cloud.

The summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an exemplary flow diagram 100 for predicting and generating LULC classification of a geographic area;

FIG. 1(a) shows the LULC classification map for the defined geographic area;

FIG. 2 schematically shows an exemplary flow diagram 200 for a method for creating training set for training a deep learning model;

FIG. 3 schematically shows a convolutional neural network architecture for training a deep learning model;

FIG. 4 schematically shows an exemplary flow diagram 400 for detecting change in LULC classes of a geographic area over different time frames;

FIG. 4(a) shows the LULC classification of the geographic area for the first time frame and the second time frame; and

FIG. 5 schematically shows a block diagram of an illustrative example of a system for predicting LULC classification of a geographic area.

### DETAILED DESCRIPTION OF THE INVENTION

Embodiments of the present invention are best understood by reference to the figures and description set forth herein. All the aspects of the embodiments described herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit and scope thereof, and the embodiments herein include all such modifications.

This description is generally drawn, inter alia, to methods, apparatuses, systems, devices, non-transitory mediums, and computer program products implemented as automated tools for predicting LULC classification of a geographic area using a trained deep learning model.

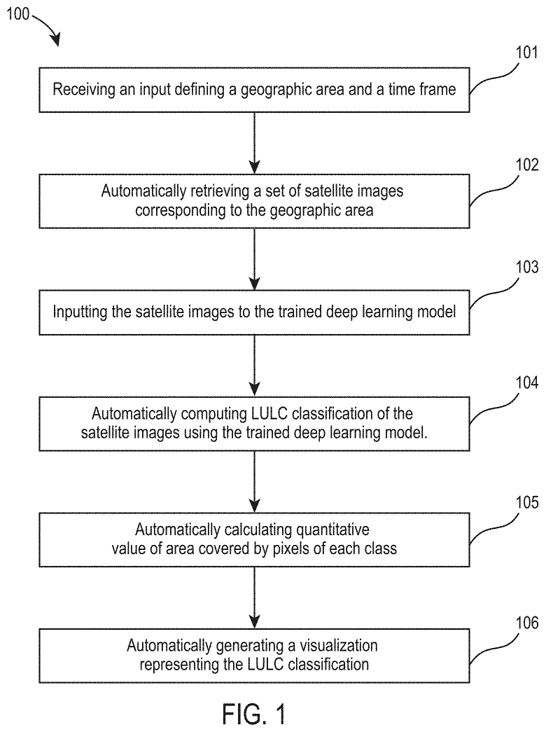

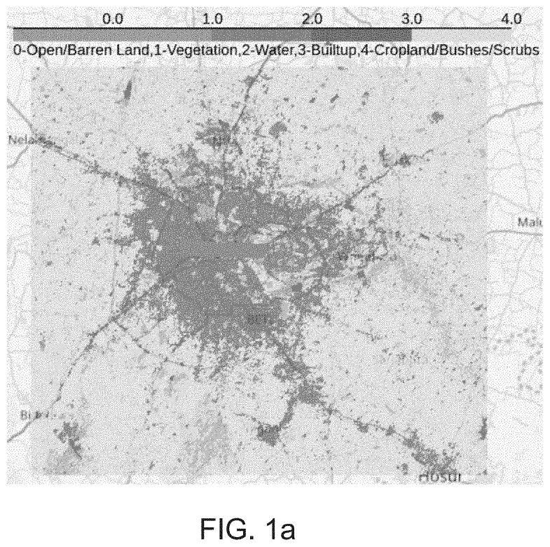

FIG. 1 schematically shows an exemplary flow diagram 100 for predicting and generating LULC classification of a geographic area, in accordance with at least some embodiments described herein.

At step 101, an input defining a geographic area and a time frame is received from a user, the input intends towards prediction of LULC classification of the defined geographic area and the time frame. In some examples, the input defining a geographic area may include but not limited to, an extent of a city, a city name, a latitude and/or longitude or any other geographic coordinates of an area. In some examples, the time frame may include but not limited to, a calendar year, a calendar date or a month. In some examples, the time frame may include a date range where the user provides a start date and an end date.

One skilled in the art will appreciate that two inputs with regard to geographic area and time frame have been described for the purpose of illustrations and not limitation. Any number of inputs with regard to geographic area and time frame throughout the methods described herein shall be considered within the spirit and scope of the present description.

Image Acquisition

At step 102, a set of satellite images corresponding to the defined geographic area and the time frame are automatically selected and retrieved from one or more servers. In some examples, Landsat-8 satellite images are retrieved from the one or more servers. In some examples, the one or more servers may include but not limited to, Google Cloud Storage, Amazon AWS S3 or USGS EROS (Earth Resources Observation and Science) database, remote database, or a local database.

In some examples, the latitude and/or longitude values of the defined geographic area are converted into pixel locations. In some examples, the satellite images are stored in tiled form on the one or more servers. The satellite images are divided into multiple tiles in UTM/WGS84 projection. Each tile has its own projection information which is used for conversion of a spherical surface to a square tile and vice versa. In some examples, a separate list of all the projection information of all the tiles is automatically created that is used for converting the latitude and/or longitude values into pixel locations.

In some examples, the tile containing the defined geographic area corresponding to the defined time frame is automatically selected and retrieved from the one or more servers. In some examples, the defined geographic area lies around tile edges and fall on multiple tiles. In such a scenario, the best tile is selected and retrieved from the one or more servers to maintain the uniformity. In some examples, the multiple tiles containing the defined geographic area are merged together and the merged tiles are retrieved from the one or more servers for further processing.

In some examples, a set of satellite images corresponding to the defined geographic area and the time frame are automatically selected and bounding box containing the defined geographic area within the satellite images is automatically computed. The image is cropped around the edges of the bounding box and the cropped image is automatically retrieved from the one or more servers.

In some examples, the bounding box falling under the UTM zones corresponding to the defined geographic area are automatically selected and corresponding tiles are automatically retrieved from the one or more servers.

In some examples, the size of the tiles of the satellite images is very large usually in megabytes (MB). In such a scenario, the raster data of the satellite images is optimized by converting the raster data into a format that is handled by using standard Python libraries.

In some examples, the Landsat level-1 product data corresponding to the defined geographic area and the time frame are automatically retrieved from the one or more servers. In some examples, geometrically corrected satellite images corresponding to the defined geographic area and time frame are automatically retrieved from the one or more servers. In some examples, the Landsat level-1 Precision and Terrain (L1TP) corrected product data corresponding to the defined geographic area and the time frame are automatically retrieved from the one or more servers. The level-1 Precision and Terrain (L1TP) corrected product data is radiometrically calibrated and orthorectified using ground control points (GCPs) and digital elevation model (DEM) data to correct for relief displacement. The highest quality Landsat level-1 products are suitable for pixel-level time series analysis.

In some examples, the satellite images having less cloud coverage are automatically selected and retrieved from the one or more servers. Cloud cover may obscure the ground underneath it and affects the satellite images which hampers the analysis results. In some examples cloud cover may include but not limited to clouds, atmospheric obstructions, such as smoke, snow, haze, or smog, or combinations thereof. In some examples, cloud based filters are used to automatically select those satellite images which have less cloud coverage. In some examples, only those satellite images which have less cloud coverage are automatically selected and retrieved from the one or more servers. In some examples, best satellite images with at most 5 percent cloud coverage corresponding to the defined geographic area and the time frame are automatically selected and retrieved from the one or more servers. In some examples, best satellite images with at most 7 percent, at most 10 percent, at most 15 percent, at most 20 percent, at most 25 percent, at most 30 percent, at most 35, or at most 40 percent cloud coverage corresponding to the defined geographic area and the time frame are automatically selected and retrieved from the one or more servers.

At step 103, the satellite images corresponding to the defined geographic area and the time frame are given as input to a trained deep learning model. In some examples, the trained deep learning model is developed using a convolutional neural network (CNN) architecture. For the purposes of the present description, Convolutional Neural Network (CNN) architecture has been considered for the purposes of the described methods and systems. However, any other deep learning network, as would be known to a person having ordinary skill in the art being used or usable for the similar purposes, be considered within the spirit and scope of the present description.

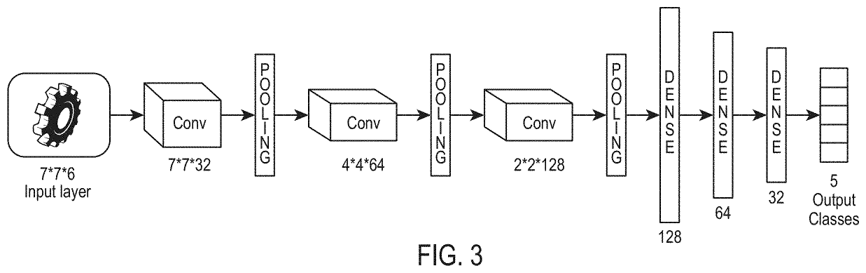

The deep learning model is trained using a large set of data known as training set, and the CNN architecture to develop the trained deep learning model. The CNN takes in inputs, which are then processed in hidden layers using weights that are updated during training. FIG. 3 schematically shows convolutional neural network architecture for training deep learning model to develop the trained deep learning model, in accordance with at least some embodiments described herein.

At step 104, the LULC classification of the defined geographic area is computed by the trained deep learning model using updated weights of the convolutional neural network. In some examples, the LULC classification may include plurality of LULC classes. In some examples, each pixel of the satellite images corresponding to the geographic area and the time frame is classified into one of the plurality of LULC classes. In some examples, the plurality of land use land cover (LULC) classes include at least one of vegetation cover, surface water cover, built-up area, barren/open land, and cropland.

At step 105, An area covered by pixels of each class is automatically calculated. In some examples, percentage of total geographic area covered by pixels of each class is calculated.

At step 106, a visualization depicting the classified pixels and the respective classification is automatically generated. In some examples, the classified pixels and the respective classification are presented on an image of the geographic area. In some examples, the classified pixels and the respective classification are presented on a map of the geographic area. In some examples, thematic maps or thematic layers representing the classified pixels and the respective classification are automatically generated. In some examples, a visualization depicting the quantitative value of the area and/or the percentage of geographic area covered by pixels of each class is automatically generated. In some examples, pixel count of each class is presented on an image or a map of the geographic area. In some examples, the quantitative value of the area and/or the percentage of geographic area covered by pixels of each class is presented on an image or a map of the geographic area. In some examples, the pixel count, and/or the quantitative value of the area and/or the percentage of geographic area covered by pixels of each class is presented in a readable output to the user. The readable output may include but not limited to, a text, a message or a tabular form.

FIG. 1(a) shows the LULC classification map for the defined geographic area. As shown in FIG. 1(a), each pixel of the satellite image has been classified into one of the classes including but not limited to vegetation cover, built-up area, cropland, surface water cover (represented by water) and barren/open land.

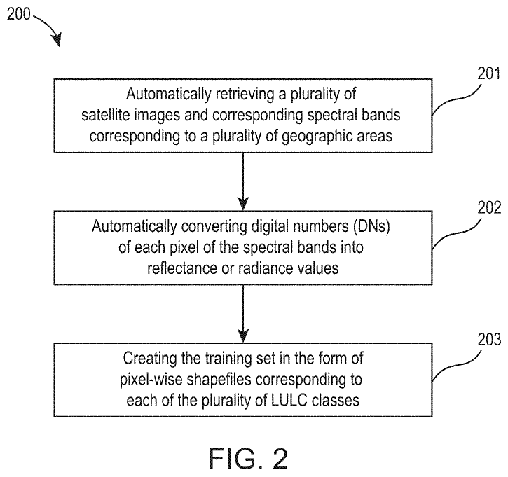

For predicting LULC classification of a geographic area, the deep learning model is trained using the training set and the CNN architecture to develop a trained deep learning model. FIG. 2 schematically shows an exemplary flow diagram for a method 200 for creating training set for training deep learning model, in accordance with at least some embodiments described herein.

At step 201, a plurality of satellite images corresponding to a plurality of geographic areas are automatically retrieved from one or more servers for creating training set for training a deep learning model. In some examples, the one or more servers may include, but not limited to, Google Cloud Storage, Amazon AWS S3, USGS EROS (Earth Resources Observation and Science), remote database, or a local database. In some examples, satellite images of plurality of cities are considered for creating training set for training a deep learning model. In some examples, satellite images of plurality of cities from each continent of the world are considered for creating training set for training a deep learning model. In some examples, satellite images of plurality of geographic areas corresponding to multiple time frames may be considered for creating training set for training a deep learning model. In some examples, the plurality of geographic areas and the time frames may be inputted by user for creating training set for training deep learning model. In some examples, Landsat satellite images of the plurality of geographic areas are considered for creating training set for training deep learning model. However, any other satellite images, as would be known to a person having ordinary skill in the art being used or usable for the similar purposes, be considered within the spirit and scope of the present description. For the purposes of the present description, the Landsat-8 satellite images have been used for the purposes of the described methods and systems. However, such usage of specific satellite images be not considered as, in any way, limiting the scope of the present description. Any other satellite mission data, as would be known to a person having ordinary skill in the art, may be considered within the spirit and scope of the present description.

In some examples, the Landsat level-1 product data corresponding to the plurality of geographic areas are automatically retrieved from the one or more servers. The highest quality Landsat level-1 products are suitable for pixel-level time series analysis. In some examples, the spectral bands or spectral band images corresponding to the plurality of geographic areas are automatically retrieved from the one or more servers. In some examples, spectral band specific satellite images corresponding to the plurality of geographic areas are automatically retrieved from the one or more servers. For the purposes of the present description, out of 11 bands of Landsat-8 satellite images, only six bands (band 2 to band 7) of the satellite images are considered for training process for the purposes of the described methods and systems. However, such usage of specific spectral bands be not considered as, in any way, limiting the scope of the present description. Any other spectral bands, as would be known to a person having ordinary skill in the art, may be considered within the spirit and scope of the present description.

In some examples, geometrically corrected satellite images are automatically retrieved from the one or more servers. In some examples, the Landsat level-1 Precision and Terrain (L1TP) corrected product data are automatically retrieved from the one or more servers. The level-1 Precision and Terrain (L1TP) corrected product data is radiometrically calibrated and orthorectified using ground control points (GCPs) and digital elevation model (DEM) data to correct for relief displacement.

In some examples, the satellite images having less cloud coverage are automatically retrieved from the one or more servers. Cloud cover may obscure the ground underneath it and affects the satellite images which hampers the analysis results. In some examples cloud cover may include but not limited to clouds, atmospheric obstructions, such as smoke, snow, haze, or smog, or combinations thereof. In some examples, cloud based filters are used to automatically select those satellite images which have less cloud coverage. In some examples, only those satellite images which have less cloud coverage are automatically selected and retrieved from the one or more servers. In some examples, best satellite images with at most 5 percent cloud coverage are automatically selected and retrieved from the one or more servers. In some examples, best satellite images with at most 7 percent, at most 10 percent, at most 15 percent, at most 20 percent, at most 25 percent, at most 30 percent, at most 35, or at most 40 percent cloud coverage are automatically retrieved from the one or more servers.

Image Processing

At step 202, digital numbers (DN) of each pixel of the spectral bands or spectral band images, corresponding to the satellite images, are automatically converted into reflectance values of the respective spectral bands. Each pixel intensity in each spectral band of the satellite image is coded using a digital number in specific bit ranges. The raw digital number of each pixel of the satellite image in each spectral band is converted into reflectance value of the respective spectral band. In some examples, the reflectance value includes Top of Atmosphere (ToA) reflectance value. In some examples, radiometric calibration is used to convert the digital numbers of each pixel of the satellite images into reflectance values. The radiometric calibration converts the digital number of each pixel of the satellite image in each spectral band into TOA reflectance value of the respective spectral band using the band-specific calibration coefficients provided in the product-specific metadata file of the level 1 product data of the Landsat. The digital numbers of each pixel of the satellite images provided in the level 1 product data are converted to TOA reflectance values using the following equation:

ρλ=(Mρ*Qcal+A ρ)/cos(θSZ); where:

ρλ=TOA Reflectance;

Mρ=Reflectance multiplicative scaling factor for the band (REFLECTANCEW_MULT_BAND_n from the metadata);

Aρ=Reflectance additive scaling factor for the band; (REFLECTANCE_ADD_BAND_N from the metadata);

Qcal=Level 1 pixel value in DN;

θSE=Local sun elevation angle; the scene center sun elevation angle in degrees is provided in the metadata;

θSZ=Local solar zenith angle; θSZ=90°−θSE.

In some examples, the digital numbers (DN) of each pixel of the spectral bands or spectral band images, corresponding to the set of satellite images, are automatically converted into radiance values of the respective spectral bands. The raw digital number of each pixel of the satellite image in each spectral band is converted into radiance value of the respective spectral band. The radiometric calibration is used to convert the digital number of each pixel of the satellite image in each spectral band into radiance value of the respective spectral band using the band-specific calibration coefficients provided in the product-specific metadata file of the level 1 product data of the satellite images using the following equation:

L=ML*Qcal+AL; where:

L=Spectral radiance (W/(m²*sr*μm));

ML=Radiance multiplicative scaling factor for the band; (RADIANCE_MULT_BAND_n from the metadata);

AL=Radiance additive scaling factor for the band; (RADIANCE_ADD_BAND_n from the metadata);

Qcal=Level 1 pixel value in DN.

For the purposes of the present description, reflectance arrays corresponding to the six spectral bands (band 2 to band 7) of the satellite images are considered for creating the training set for the purposes of the described methods and systems. However, such usage of specific spectral bands be not considered as, in any way, limiting the scope of the present description. Any other spectral bands, as would be known to a person having ordinary skill in the art, may be considered within the spirit and scope of the present description.

At step 203, the training set is created pixel-wise in the form of shapefiles corresponding to each of the plurality of LULC classes. In some examples, training sets are created pixel-wise in the form of shapefiles for the LULC classes using an open-source GIS software. In some examples, the reflectance arrays corresponding to the six spectral bands (band 2 to band 7) of the satellite images are given as input to the open-source GIS software and the training set including pixel-wise shapefiles for the LULC classes is generated by the open-source GIS software. The LULC classes may include but not limited to Vegetation, Waterbody, Built-up, Barren/open land and Cropland (agriculture+current fallow). For the purposes of the present description, only five LULC classes have been considered for the purposes of the described methods and systems. However, any other LULC classes, as would be known to a person having ordinary skill in the art being used or usable for the similar purposes, be considered within the spirit and scope of the present description. In some examples, the generated shapefiles are further converted into raster format to be used as input to develop deep learning based model.

The created training set is used to train a deep learning model to develop the trained deep learning model to predict LULC classification of a geographic area.

FIG. 3 schematically shows convolutional neural network architecture for training deep learning model to develop the trained deep learning model, in accordance with at least some embodiments described herein.

As shown in FIG. 3, the reflectance arrays corresponding to the six spectral bands (band 2 to band 7) of the satellite images and the training set including pixel-wise shapefiles corresponding to the LULC classes in raster format are given as inputs to the CNN. The CNN may include a combination of convolution layer, activation function, pooling layer and fully-connected layer. In some examples, ReLU is used as an activation function. In some examples, the input to the convolution layer of the CNN may include a multidimensional array of data that defines the various spectral bands of an input image. For the purposes of the present description, out of 11 bands of Landsat-8 satellite images, only six bands (band 2 to band 7) of the satellite images are considered for training process for the purposes of the described methods and systems. However, such usage of specific spectral bands be not considered as, in any way, limiting the scope of the present description. Any other spectral bands, as would be known to a person having ordinary skill in the art, may be considered within the spirit and scope of the present description. The input pixel values are compared with the training set including the pixel wise shape-files corresponding to the LULC classes. The neural network is able to learn both the spectral and spatial features of the satellite images by concatenating the extracted feature maps before and after the convolutional layers. The convolutional layer includes convolution filter. The convolution filter may include multidimensional array of weights. The convolution filter within the convolution layers generate feature map when applied to input image. For reducing the spatial resolution and making the feature more invariant to shift, the feature maps are fed to the pooling layers. The pooled feature maps constitute inputs to the next pair of layers. In some examples, hyper-parameters like the number of layers, the kernel size and the number of kernels in the convolutional layers may be set automatically or manually. The weights in the filter kernels are updated using the backpropagation procedure using annotated pixels. The training of neural network involves calculation of loss function based on differences among input pixel values and ground truth values. Each weight in the filter contributes to each pixel in the output map. Thus, any change in a weight in the filter will affect all the output pixels. Thus, all these changes add up to contribute to the final loss. Weight computation is dependent on the value of loss. The losses can be optimized by using optimizers like gradient descent, Adagrad, AdaDelta, Adaptive Moment Estimation (Adam) etc. The Adaptive Moment Estimation (Adam) computes learning rates which are adaptive for each parameter. In some examples, the updated weights are saved in a file to be used for predicting the LULC classification of a geographic area. At last, each pixel of the Landsat satellite images are trained for one of the LULC classes. The trained deep learning model is used for predicting LULC classification of a geographic area using the updated weights of the CNN.

Deep Learning Overview

A deep learning algorithm is a machine learning algorithm that learns to perform various image classification tasks by learning various features directly from the data. The deep learning models are trained using a large set of data known as training set and using neural network architectures. An exemplary type of neural network is a convolutional neural networks (CNN or ConvNet). The CNN is a deep learning algorithm which can take in an input image, assign filters to various aspects in the image and be able to differentiate one from the other. CNN is able to capture the spatial and temporal dependencies in an image through the application of relevant filters. The CNN includes a feed-forward network which includes an input layer and an output layer that are separated by at least one hidden layer. The nodes in the CNN input layer are organized into a set of filters and the output of each set of filters is propagated to nodes in successive layers of the network. The computations for a CNN include applying the convolution mathematical operation to each filter to produce the output of that filter. In convolutional network terminology, the first function to the convolution can be referred to as the input, while the second function can be referred to as the convolution kernel or filter. The output may be referred to as the feature map.

Various layers are used in CNN as described below:

Convolution Layer

The convolution operation is used to extract high-level features from the input image. For this purpose, a kernel of specific size is parsed over the image with specific stride until the full image is parsed.

Activation Function

Activation function takes a single neuron and performs some non-linear mathematical operation on it. Commonly used activation functions are ReLU, sigmoid, tanh etc. ReLU (Rectified Linear Unit) function does thresholding at zero i.e. all negative inputs are converted to zero and that particular neuron is not activated. ReLU is widely used because of its advantage that it does not stimulate all neurons simultaneously. This makes computation efficient. ReLU converges faster than sigmoid and tanh activation functions.

Pooling Layer

Pooling is used to reduce the computational power needed to analyze the data via dimensionality reduction. It maintains effectiveness of training of model by extracting positional invariant and rotational features. Max pooling and average pooling are generally used.

Batch Normalization

Batch normalization is a well-accomplished technique built to automatically standardize the inputs to a layer in deep learning neural network. Using batch normalization, the training process of network can be accelerated and model performance can be improved. Batch normalization reduces the quantity by which the hidden unit values shift around.

Fully-Connected layer

The output obtained from above layers is flattened into a column vector and given to a feed-forward neural network. Each number of iterations applies back propagation during training. After some epochs, the model can discriminate among different features and apply softmax classification to classify entire image. Softmax function determines the probability of each class label over all given target labels. The output range of softmax is 0 to 1. Hence, the class having higher probability will be assigned as target class for the corresponding pixel.

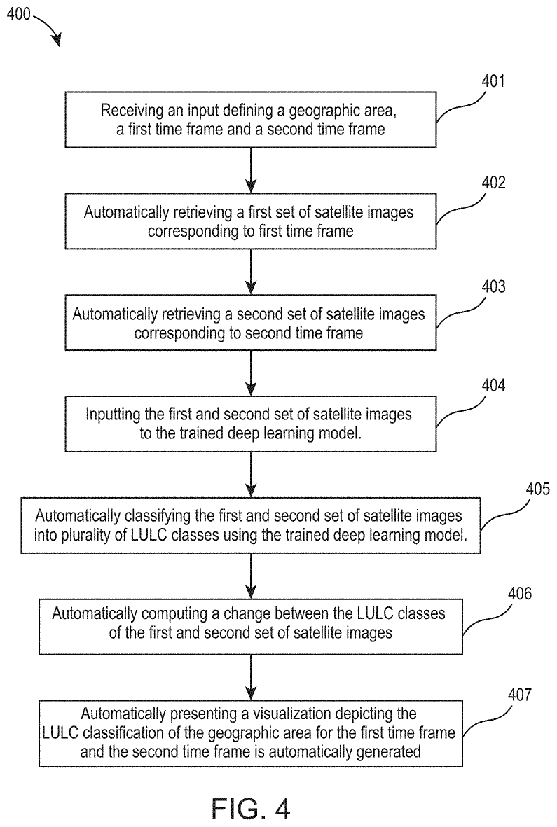

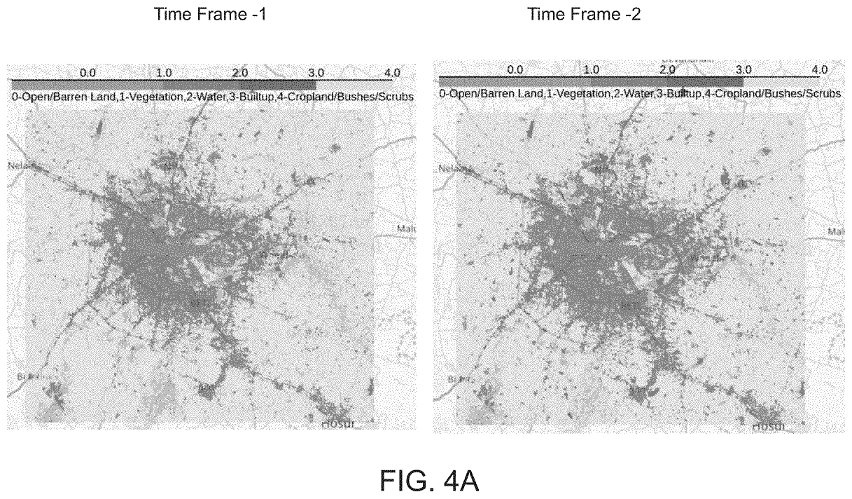

FIG. 4 schematically shows an exemplary flow diagram 400 for detecting change in LULC classes of a geographic area over different time frames.

At step 401, a first input defining a geographic area and a first time frame and a second input defining a second time frame is received from the user. The inputs are intended towards change detection in LULC classes of the geographic area between the first and the second time frame for the defined geographic area.

At step 402, a first set of images corresponding to the defined geographic area and the first time frame are automatically selected and retrieved from the one or more servers.

At step 403, a second set of images corresponding to the defined geographic area and the second time frame are automatically selected and retrieved from the one or more servers.

At step 404, the first and second set of satellite images are given as input to the trained deep learning model.

At step 405, the first and second set of satellite images are classified into plurality of LULC classes by the trained deep learning model using the updated weights and the CNN. In some examples, each pixel of the first and second set of satellite images is classified into one of the plurality of LULC classes. In some examples, the plurality of land use land cover (LULC) classes include at least one of vegetation cover, surface water cover, built-up area, barren/open land, and cropland.

At step 406, a change between the LULC classes of the first and second set of satellite images is automatically computed.

At step 407, a visualization presenting the LULC classification of the geographic area for the first time frame and the second time frame is automatically generated and presented on the satellite images of the geographic area. In some examples, a visualization presenting the quantitative value of the change in the land use land cover (LULC) classes of the first and the second set of satellite images, between the first time frame and the second time frame is automatically generated. In some examples, a change map representing the quantitative statistical measurements of the LULC classes of the geographic area for first time frame and second time frame is automatically generated and presented on an image of the geographic area. In some examples, the change map shows the relative changes in similar class, between the first time frame and the second time frame. In some examples, percentage change in area covered by each class is generated and presented to the user.

As an example, FIG. 4(a) shows the LULC classification of the geographic area for the first time frame and the second time frame.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

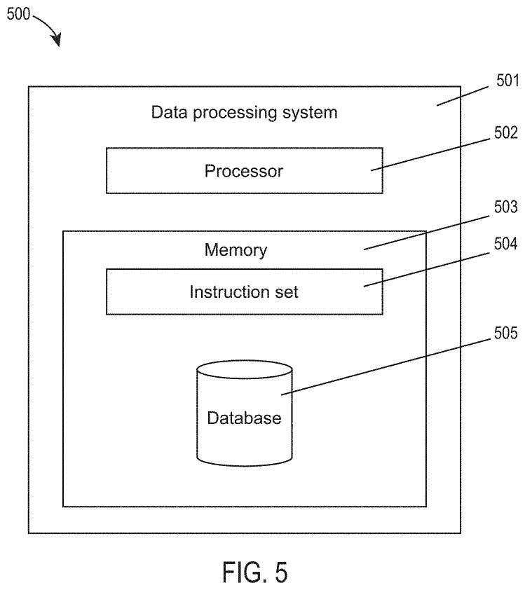

FIG. 5 schematically shows a block diagram of an illustrative example of a system 500 for geospatial analysis for determining and presenting suitable sites for the facility type, arranged in accordance with at least some embodiments described herein. As depicted in FIG. 5, the system 500 includes a data processing system 501, which comprises at least one processor 502 and at least one memory 503. The memory 503 comprises an instruction set storage 504 and a database 505. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof. The system components may be provided by one or more server computers and associated components.

In some examples, the data processing system 501, with use of the processor 502, may be configured, based on execution of one or more instructions stored on the instruction set storage 504 and/or database 505, to perform some or all the operations of the methods 100 as detailed above.

It is to be noted herein that various aspects and objects of the present invention described above as methods and processes should be understood to an ordinary skilled in the art as being implemented using a system that includes a computer that has a CPU, display, memory and input devices such as a keyboard and mouse. According to an embodiment, the system is implemented as computer readable and executable instructions stored on a computer readable media for execution by a general or special purpose processor. The system may also include associated hardware and/or software components to carry out the above described method functions. The system is preferably connected to an internet connection to receive and transmit data.

The term “computer-readable media” as used herein refers to any medium that provides or participates in providing instructions to the processor of the computer (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this invention. Furthermore, not all of the features, aspects and advantages are necessarily required to practice the present invention. Thus, while the above detailed description has shown, described, and pointed out novel features of the invention as applied to various embodiments, it will be understood that various omissions, substitutions, and changes in the form and details of the apparatus or process illustrated may be made by those of ordinary skill in the technology without departing from the spirit of the invention. The inventions may be embodied in other specific forms not explicitly described herein. The embodiments described above are to be considered in all respects as illustrative only and not restrictive in any manner Thus, scope of the invention is indicated by the following claims rather than by the above description.

What is claimed is:

1. A computer-implemented method for generating land use land cover (LULC) classification of a geographic area, said method comprising:
receiving a first input defining a geographic area and a first time frame;
automatically retrieving a first set of satellite images corresponding to the geographic area and the first time frame;
automatically classifying the first set of satellite images into a plurality of land use land cover (LULC) classes using a trained deep learning model; and
automatically presenting a visualization depicting the LULC classification of the geographic area.

2. The computer-implemented method of claim 1, wherein the plurality of land use land cover (LULC) classes include at least one of vegetation cover, surface water cover, built-up area, barren/open land, and cropland.

3. The computer-implemented method of claim 1, wherein the computer-implemented method further comprises:
creating a training set including a plurality of satellite images; and
automatically training a deep learning model using the training set and a neural network to develop the trained deep learning model.

4. The computer-implemented method of claim 3, wherein said creating a training set comprises:
automatically retrieving the plurality of satellite images corresponding to a plurality of geographic areas;
automatically fetching a plurality of spectral bands corresponding to the plurality of satellite images;
automatically processing the plurality of spectral bands to convert digital number of each pixel of the plurality of spectral bands into reflectance or radiance values; and
creating the training set in the form of pixel-wise shapefiles corresponding to each of the plurality of LULC classes.

5. The computer-implemented method of claim 4, wherein said automatically retrieving a plurality of satellite images includes automatically selecting and retrieving satellite images with at most 5 percent cloud coverage from one or more servers.

6. The computer-implemented method of claim 4, wherein said automatically training a deep learning model comprises:
automatically training the deep learning model using the pixel reflectance or radiance values of the plurality of spectral bands, and the training set as inputs to the neural network.

7. The computer-implemented method of claim 6, wherein the neural network includes a convolution layer, activation function, pooling layer, and fully-connected layer.

8. The computer-implemented method of claim 6, wherein said automatically training a deep learning model comprises:
automatically calculating a loss value based on differences among the input pixel values and ground truth values;
automatically performing back propagation; and
automatically updating weights corresponding to each layer of the neural network.

9. The computer-implemented method of claim 1, wherein the computer-implemented method further comprises automatically calculating a quantitative value of an area covered by pixels of each LULC class, and said automatically presenting a visualization depicting the LULC classification of the geographic area includes automatically presenting the area covered by the pixels of each LULC class on an image of the geographic area.

10. The computer-implemented method of claim 1, the computer-implemented method further comprises:
receiving a second input defining a second time frame;
automatically retrieving a second set of satellite images corresponding to the geographic area and the second time frame;
automatically classifying the second set of satellite images into a plurality of land use land cover (LULC) classes using a trained deep learning model; and
automatically presenting a visualization depicting a comparison of the land use land cover (LULC) classes of the first and the second set of satellite images, the comparison illustrating a quantitative relative change in the land use land cover (LULC) classes of the geographic area over a time duration from the first time frame to the second time frame.

11. A system for generating land use land cover (LULC) classification of a geographic area, said system comprising:
at least one processor;
a memory that is coupled to the at least one processor and that includes computer-executable instructions, wherein the at least one processor, based on execution of the computer-executable instructions, is configured to:
receive a first input defining a geographic area and a first time frame;
retrieve a first set of satellite images corresponding to the geographic area and the first time frame;
classify the first set of satellite images into a plurality of land use land cover (LULC) classes using a trained deep learning model; and
present a visualization depicting the LULC classification of the geographic area.

12. The system of claim 11, wherein the plurality of land use land cover (LULC) classes include at least one of vegetation cover, surface water cover, built-up area, barren/open land, and cropland.

13. The system of claim 11, wherein the at least one processor is further configured to:
create a training set including a plurality of satellite images; and
train a deep learning model using the training set and a neural network to develop the trained deep learning model.

14. The system of claim 13, wherein the at least one processor is further configured to create a training set includes the at least one processor being configured to:
retrieve a plurality of satellite images corresponding to a plurality of geographic areas;
fetch a plurality of spectral bands corresponding to the plurality of satellite images;
process the plurality of spectral bands to convert digital number of each pixel of the plurality of spectral bands into reflectance or radiance values; and
create the training set in the form of pixel-wise shapefiles corresponding to each of the plurality of LULC classes.

15. The system of claim 14, wherein the at least one processor being configured to retrieve a plurality of satellite images includes the at least one processor being configured to select and retrieve satellite images with at most 5 percent cloud coverage from one or more servers.

16. The system of claim 14, wherein the at least one processor being configured to train a deep learning model includes the at least one processor being configured to:
train the deep learning model using the pixel reflectance or radiance values of the plurality of spectral bands, and the training set as inputs to the neural network.

17. The system of claim 16, wherein the neural network includes a convolution layer, activation function, pooling layer, and fully-connected layer.

18. The system of claim 16, wherein the at least one processor being configured to train a deep learning model includes the at least one processor being configured to:
calculate a loss value based on differences among the input pixel values and ground truth values;
perform back propagation; and
update weights corresponding to each layer of the neural network.

19. The system of claim 11, wherein the at least one processor is further configured to calculate a quantitative value of an area covered by pixels of each LULC class, and the at least one processor being configured to present a visualization depicting the LULC classification of the geographic area includes the at least one processor being configured to present the area covered by the pixels of each LULC class on an image of the geographic area.

20. The system of claim 11, the at least one processor is further configured to:
receive a second input defining a second time frame;
retrieve a second set of satellite images corresponding to the geographic area and the second time frame;
classify the second set of satellite images into a plurality of land use land cover (LULC) classes using a trained deep learning model; and
present a visualization depicting a comparison of the land use land cover (LULC) classes of the first and the second set of satellite images, the comparison illustrating a quantitative relative change in the land use land cover (LULC) classes of the geographic area over a time duration from the first time frame to the second time frame.

21. A computer-readable medium that comprises computer-executable instructions that, based on execution by at least one processor of a computing device that includes memory, cause the computing device to perform one or more steps of the method of claim 1.
